(19) United States
(12) Patent Application Publication
(10) Pub. No.: US 2026/0081881 A1
(43) Pub. Date: Mar. 19, 2026

(54) GENERATION OF DATA-GROUNDED EMAILS FOR AUTO-RESPONSE

(71) Applicant: Salesforce, Inc., San Francisco, CA (US)

(72) Inventors: Jared LONG, Cambridge, MA (US); Matthew NIELSEN, San Francisco, CA (US); Mykhailo BAKIROV, San Francisco, CA (US); Aron KALE, San Francisco, CA (US); Monil SANGHAVI, San Francisco, CA (US); Swapna KASULA, San Francisco, CA (US); Itamar AFEK, San Francisco, CA (US); Nikhil BOJJA, San Francisco, CA (US); Nachiketa MISHRA, San Francisco, CA (US); Nan SHAO, San Francisco, CA (US); Sanmitra IJERI, San Francisco, CA (US)

(73) Assignee: Salesforce, Inc., San Francisco, CA (US)

(21) Appl. No.: 18/973,458

(22) Filed: Dec. 9, 2024

Related U.S. Application Data
(60) Provisional application No. 63/695,243, filed on Sep. 16, 2024.

(51) Int. Cl. H04L 51/02; G06F 40/284

(52) U.S. Cl. CPC H04L 51/02; G06F 40/284

(57) ABSTRACT

Disclosed herein are system, method, and computer program product aspects for response drafting, grounding, generation, and/or auto-response. A similarity search is performed within a database storing data chunks representing knowledge information that corresponds to a user to obtain top-k data chunks associated with an email from the user. A prompt is generated based on the email, the top-k data chunks, and one or more instructions directing a large language model (LLM) to generate related content for responding to the email. The LLM is then queried with the prompt. In addition, a response to the email is generated based on incorporating the related content into a response template.

### BACKGROUND

A Large Language Model (LLM) is a machine learning model that can comprehend and generate human language text and other generative outputs based on a large data training set. LLMs are becoming integrated into a wide variety of fields, such as research, agent response, healthcare, translation, content creation, and a wide array of business applications.

In order to cause a LLM to produce a responsive action, such as automatically drafting emails as auto-response back to the original sensor, it is often necessary to write a prompt to steer the LLM to perform this email response generation. This prompt is essentially an instruction to the LLM in which different LLMs may use different prompts, and one prompt may not necessarily be interchangeable with another.

This disclosure is generally directed to a response generation system, and more particularly to a LLM-enabled response generation system for email response drafting, grounding, generation, and/or auto-response.

### BRIEF DESCRIPTION OF THE FIGURES

The accompanying drawings are incorporated herein and form a part of the specification.

FIG. 1 is a block diagram of a response generation system, according to aspects of the present disclosure.

FIG. 2 is a response generation flow of a response generation system, according to aspects of the present disclosure.

FIG. 3 is a flowchart illustrating a method for response drafting, grounding, generation, and/or auto-response, according to aspects of the present disclosure.

FIG. 4 illustrates an example computer system useful for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for response drafting, grounding, generation, and/or auto-response.

Implementations described herein may generate response of an email inquiry based on artificial intelligence (AI) data grounding. AI data ground may refer to a process of using a LLM with information that is use-case specific, relevant, and not available as part of the LLM trained knowledge. It may be crucial for ensuring the quality, accuracy, and relevance of the generated LLM response in which the LLM may need to be grounded in the context of specific use-cases to combine the general capabilities of LLMs with specific information relevant to the use-cases. In some aspects, the response generation system described herein may then query the LLM based on a prompt including but not limited to the grounded data, the user query contexts, and/or the user instruction. The LLM may then generate the related content for response (e.g., body of the response email) of the user query (e.g., email inquiry). The response generation may then generate a response to the user query based on incorporating the related content into a response template selected based on a user configuration. In some aspects, the LLM may include multi-modal support, being capable of receiving in a prompt and/or outputting one or more images, audio, and/or video. In some aspects, the response generation system described herein may determine whether the quality of the generated response has achieved a quality threshold. The response generation system may send the generated response back to the user based on the generated response having achieved the quality threshold, or route the generated response to an agent for review based on the generated response not having achieved the quality threshold. In addition, after incorporating the feedback from agent into the generated response, the response generation system may then sent the updated response back to the user.

Traditional response generation systems suffer from various technological problems and challenges associated with email response generation. Response generation system may include but is not limited to absorbing the context of a text (e.g., email inquiry), identifying key pieces of information from the text, and/or generating a cohesive response based on the extracted information by combining and/or grounding multiple source points together. Some response generation system systems reply on natural language processing (NLP) models to generate the response to the text data. However, many NLP models struggle with context and ambiguity, leading to misinterpretations due to the rule-based nature of NLP models.

Implementations described herein solve these technological challenges associated with processing complex text data through the use of a LLM in conjunction with querying the LLM based on a generated textual prompt from the user query and the AI grounded data. The LLM may handle the complex text data since LLMs are trained on vast datasets from diverse text sources with extensive corpus of information. This approach may allow the LLM to adapt to various text styles and formats, and tackle various language tasks without needing specific training for each task. Furthermore, AI data grounding may enable the response generation system to leverage the power of LLMs while incorporating the necessary context and data in terms of retrieving information relevant to a task, providing it to the LLM along with a prompt, and relying on the LLM to use this specific information when responding. Grounding AI involves using methods and mechanisms that allow an AI to reference and understand concrete subjects, objects, and scenarios while engaging in conversation or decision-making processes, especially in conjunction with querying the LLM. This connection between LLM with AI data grounding is crucial for LLM to participate in meaningful dialogues, answer questions, email response, or follow instructions that involve understanding the environment, human intentions, or abstract concepts. In addition, the response generation system may apply a vector search and leverage a vector database to retrieve the relevant ground data for a user query. Compared to traditional keyword search, vector search may yield more relevant results and execute in a faster manner. Algorithms like nearest neighbor and approximate nearest neighbor (ANN) may be leveraged by the response generation system as efficient methods to process and rank large volumes of texts and/or documents in the database for AI data grounding of search queries.

When generating the response of an email inquiry, traditional response generation systems also suffer from a lack of flexibility to configure the LLM response with a user configuration, for example, positioning and/or organize different contexts (including the LLM-generated related content) on a template for responding an email inquiry. In order to take further advantage of the response generation system for generating response for an email inquiry, aspects of the present disclosure further provide mechanisms for configuring the location of the email template where in the generated content will be placed. The response generation system may provide a customized syntax for the user via a user interface to identify user attributes or preference in placing different contents or contexts within an email template. The response generation system may also allow drag and drop to add one or more elements including but not limited to subject, body, attachment, and/or related records into the email template layout, enabling the flexibility of configuring the LLM response.

In summary, the response generation system, by using LLM in conjunction with AI data grounding and customized user confirmation, can backend the composition of emails in the system which automatically includes data grounding and completely removing the human from the process of drafting an email. This response generation system may provide agents with a starting point in responding to customers, or for some use cases, it can entirely remove the tasks from the agent's workload, allowing agents to focus on more complex customer issues—the response generation system may use generative AI to write data-grounded emails that can be sent directly to the original sender all without the involvement of a human being. These and other aspects of the present disclosure will be described in further detail below with respect to the accompanying drawings.

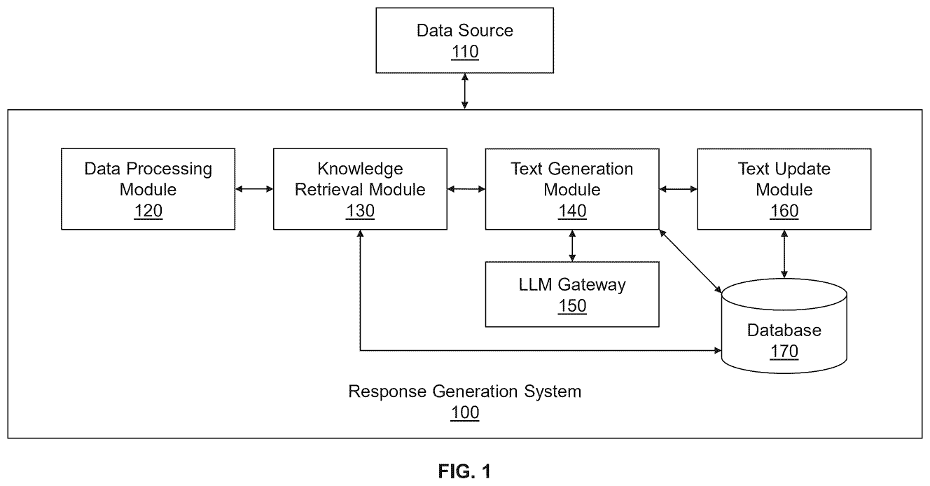

FIG. 1 is a block diagram of response generation system 100, according to aspects of the present disclosure. In some aspects, response generation system 100 may include but is not limited to a data processing module 120, a knowledge retrieval module 130, a text generation module 140, a LLM gateway 150, a text update module 160, and/or a database 170. Data processing module 120 may include one or more processors, buffers, servers, routers, modems, antennae, and/or circuitry configured to interface with knowledge retrieval module 130. Knowledge retrieval module 130 may include one or more processors, buffers, servers, routers, modems, antennae, and/or circuitry configured to interface with data processing module 120, text generation module 140, and/or database 170. Text generation module 140 may include one or more processors, buffers, servers, routers, modems, antennae, and/or circuitry configured to interface with knowledge retrieval module 130, LLM gateway 150, text update module 160, and/or database 170. Text update module 160 may include one or more processors, buffers, servers, routers, modems, antennae, and/or circuitry configured to interface with text generation module 140, and/or database 170.

In some aspects, data source 110 may be a separate computing platform including but not limited to smartphones, tablet computers, laptop computers, desktop computers, web browsers, and/or other computing devices, apparatuses, systems, or platforms. In some aspects, data source 110 may transmit information to text summarization system 100 either in a wired or wireless manner and may be, for example, the Internet, a Local Area Network, or a Wide Area Network. The transmission may utilize a network protocol, such as, for example, a hypertext transfer protocol (HTTP), a TCP/IP protocol, Ethernet, or an asynchronous transfer mode.

In some aspects, response generation system 100 may receive data from data source 110. The data from data source 110 may include user instruction data, user prompt data, user configuration data, and/or other data including but not limited to inquiry emails about a case order (e.g., pre-defined in database 170) from a sender (e.g., a user), relevant knowledge articles that address the inquiry, and any feedback from an agent regarding the generated response from response generation system 100. The user instruction data may refer to any information or message conveyed in phrases that a user would use to describe what they want to do including but not limited to in the form of text, speech, voice, and/or other modalities. The user instruction data may include but is not limited to commands and/or syntax to more complex sentences, paragraphs, and/or questions. The user prompt data, received from a prompt builder configured to generate a generative AI prompt by filling in (“hydrating”) variable placeholders (merge fields) in a prompt template with data values and packaging context data from data source 110, may include but not limited to definition of custom response generation logic for an object by creating a custom response generation prompt template bounded to that object. The user prompt data may support the ability to define additional attributes per template, allowing response generation system 100 to differentiate between templates in a more accurate way using user attributes. Along with user prompt data, the user configuration data may refer to these user attributes defined per template and/or a user preference for generating the response, including but not limited to a user profile, and/or any parameters such as subject, body, and related records for an email template.

After response generation system 100 receives the data from data source 110, data processing module 120 may be triggered by the data characteristics that matches predefined criteria in data processing module 120. These criteria may be determined based on a list of factors including but not limited to types of data input, the system capabilities, the computational resource, and/or any transmission effects. Data processing module 120 may then process the data from data source 110 based on the criteria. The data processing may include but is not limited to data preprocessing, data converting (e.g., data chunking, data vectorization, etc.), and/or data embedding.

After the data from data source 110 is processed at data processing module 120, data processing module 120 may transmit the processed data to a knowledge retrieval module 130. The processed data may include but is not limited to an inquiry email about a case order from a sender, relevant knowledge articles that address the inquiry, and/or any user contexts. The relevant knowledge articles may be processed and stored into database 170 before runtime processing. In response to the processed data, for example, a processed inquiry email from data processing module 120, knowledge retrieval module 130 may then perform search within database 170 to retrieve the relevant knowledge articles. The retrieved knowledge articles may be represented in the form of data chunks and multiple data chunks may be combined from one or more knowledge articles as to form an output of knowledge retrieval module 130.

Text generation module 140 may receive user prompt data directly from the prompt builder of data source 110 to build custom response generation prompt templates for different email inquiries. Text generation module 140 may generate a textual prompt based on the received email inquiry, the retrieved data chunks, and/or a user instruction data. Text generation module 140 may then query one or more LLMs across the internet for a response via a LLM gateway 150. LLM gateway 150 may act as a critical intermediary, channeling requests to the LLM service and handling responses. LLM gateway 150 may perform essential post-processing, enhancing the utility and effectiveness of the LLM interactions for safe and responsible use. LLM gateway 150 may also extend to performing critical post-processing tasks, adding significant value and functionality to the LLM service's output. The response from the LLM via LLM gateway 150 may include but is not limited to a related content for responding the received email inquiry.

After receiving the response from the LLM via LLM gateway 150, text generation module 140 may incorporate the LLM response (e.g. the related content for responding the email inquiry) into a response template to generate a response to the received email inquiry. The response template may be selected based on a user configuration from data source 110. Text generation module 140 may then determine whether the generated response has achieved a quality threshold for an auto-response of the received email inquiry. In some aspects, if the generated response achieves the quality threshold, text generation module 140 may transmit the generated response as an auto-response back to the original sender and/or update the case order in database 170 using the generated response from text generation module 140. If the generated response does not achieve the quality threshold, text generation module 140 may transmit the generated response to text update module 160.

Text update module 160 may receive feedback from an agent regarding the generated response directly from data source 110. Text update module 160 may update the generated response based on the feedback to generate an updated response for the email inquiry. Text generation module 140 may then transmit the updated response as a response back to the original sender. Text update module 160 may then update the case order in database 170 using the updated response from text update module 160.

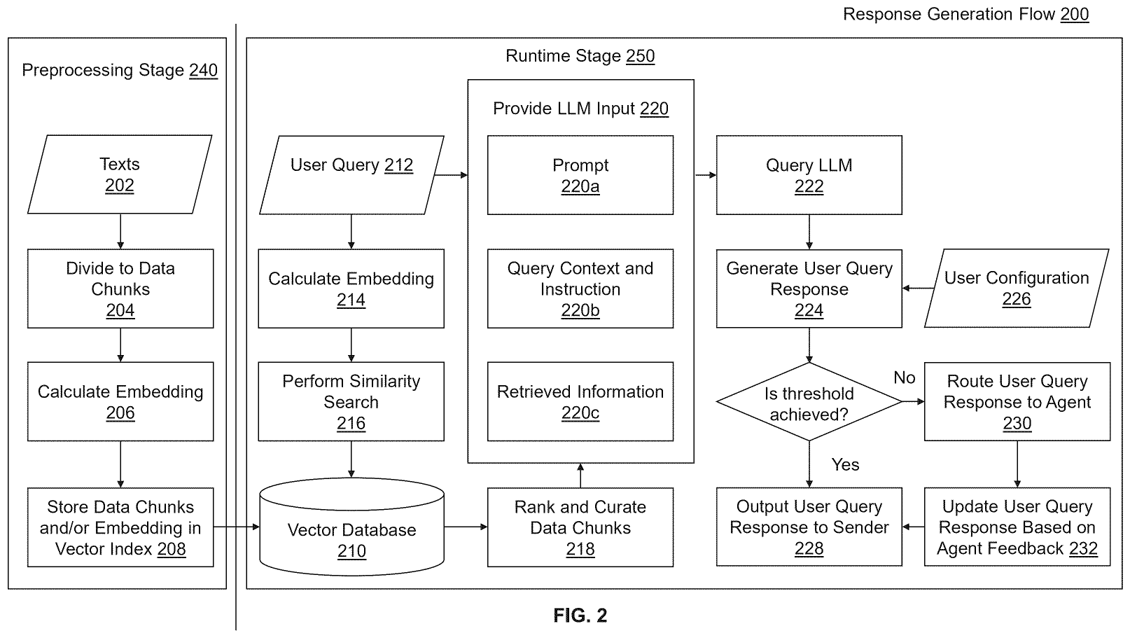

FIG. 2 is a response generation flow of a response generation system 100, according to aspects of the present disclosure. In some aspects, response generation system 100 may include two stages, a preprocessing stage 240 and a runtime stage 250. In the preprocessing stage 240, response generation system 100 may take texts and divide them into data chunks and/or fragments. The reasons for doing this text division may include indexing more specific information and fitting the limited context window of the LLM. Response generation system 100 may calculate embedding for each data chunk and then store the data chunks and/or their embedding in a vector index. In the runtime stage 250, response generation system 100 may receive a user query (e.g., query context and/or instruction). Response generation system 100 may also calculate embedding for the user query, and then perform a similarity search to retrieve the relevant texts and/or documents within database 170 that are semantically close to the user query, and/or its calculated embedding. Response generation system 100 may rank and curate the retrieved texts and/or documents, and construct the LLM input to be sent to the LLM via LLM gateway 150 based on the curated texts, the query contexts, and/or the prompt for steering the LLM.

### Preprocessing Stage

In some aspects, response generation system 100 may include a preprocessing stage 240. After receiving texts 202 from data source 110, response generation system 100, in the preprocessing stage 240, may perform operations at least to divide texts to data chunks 204, calculate embedding 206, and/or store data chunks and/or embedding in vector index 208. A vector database 210 may then be constructed to manage the stored vector index from 208.

In 204, texts 202 may be divided and/or tokenized into data chunks. A data chunk is a set of text from the original text that is smaller than the text. In some aspects, the data chunks may include a paragraph. In some aspects, the data chunks may include one or more sentences. In some aspects, portions of data chunks may overlap. The data chunking approaches may include but are not limited to semantic chunking, recursive chunking, structural chunking, fixed-sized chunking, and/or content-aware chunking. Chunking is an essential technique that may help optimize the relevance of the content retrieved from a vector database provided an embedded content. The quality of the content retrieved from the LLM can be influenced by the chunking strategy. The optimal chunk size is a balance between small and specific data chunks and larger, more comprehensive ones. The chunk overlap may be effective to ensure continuity and context between chunks, preventing the segmentation from disrupting the flow and coherence of the texts.

In 206, the embedding may be calculated for the data chunks obtained from 204. The embedding is a multi-dimensional numerical representation of “meaning” produced by the data chunks. For example, when given a data chunk input, the embedding output may be a vector with numbers—that is, the idea is to represent the semantics of text and/or data chunks in a multi-dimensional space, allowing for efficient and accurate semantic and/or similarity search to be performed. The data embedding approaches may include but are not limited to one-hot encoding, Bag of Words (BOW), Term Frequency and Inverse document Frequency (TF-IDF), Word2Vec, Skip-Gram, and/or pre-trained word-embedding using embedding layers.

In 208, the vector index may be used to store the data chunks from 204 and/or the calculated embedding from 206. A vector index is a data structure to efficiently store and retrieve high-dimensional vector data (e.g., the data chunk and/or its embedding), enabling fast similarity searches and nearest neighbor queries. This vector indexing technique may involve neatly arranging the high-dimensional vectors in a searchable and efficient manner. This arrangement may be done in a way that similar vectors and/or embedding are grouped together, by which vector indexing allows quick and accurate similarity searches and pattern identification, especially for searching large and complex datasets. The vector indexing approaches may include but are not limited to an Inverted File (IVF), variants of IVF (e.g., IVF-flat, IVF-product quantization, and/or IVF-scalar quantization), and/or a Hierarchical Navigable Small World (HNSW) algorithm (e.g., probability skip list, and/or NSW). In addition, a vector database 210 may be constructed to manage the vector index from 208. The functionalities of vector database 210 may include but are not limited to data management, metadata storage and filtering, scalability, real-time updates, backups and collections, ecosystem integration, and/or data security and access control.

### Runtime Stage

In some aspects, response generation system 100 may include a runtime stage 250. After receiving a user query 212 from data source 110, response generation system 100, in the runtime stage 250, may perform operations at least to calculate embedding 214, perform similarity search 216 within vector database 210, and/or rank and curate data chunks 218 retrieved from vector database 210. In the runtime stage 250, response generation system 100 may provide LLM input 220. The LLM input may include but is not limited to prompt 220a, query context 220b, and/or retrieved information 220c. Response generation system may then perform operations at least to query LLM 222, and/or generate user query response 224 based on incorporating the LLM query response obtained from 222 and/or a received user configuration 226. In addition, if a threshold is achieved, response generation system 100 may output user query response to sender 228. Otherwise, response generation system 100 may route user query response to agent 232, update user query response based on agent feedback 232, and/or then output user query response to sender 228.

In 214, the embedding may be calculated for user query 212. The embedding may be calculated to represent the semantics of user query 212 in a multi-dimensional space, allowing for efficient and accurate semantic and/or similarity search to be performed. In some aspects, the embedding approaches applied in 214 may be substantially similar to the embedding approaches at 206, but the embedding approaches applied in 214 may also differ from the embedding approaches at 206.

In some aspects, data items of user query 212 (with multiple modalities) may first be converted into vectors using a feature extraction and/or embedding technique. For example, text documents can be represented as vectors using word embedding and/or sentence embedding including but not limited to Bag-of-words (BoW) model, word embedding (e.g., Word2Vec, GloVe), and/or pre-trained language models (e.g., BERT, GPT). Images can be represented as vectors using convolutional neural networks (CNNs) including but not limited to pre-trained models such as VGG, ResNet, Inception, and MobileNet—the models can be used as feature extractors to create image embedding, that is, the output of a specific layer or a combination of layer outputs can be used as the embedding. The unsupervised models including autoencoders may also be used for embedding image data-by learning to compress and reconstruct images in which the compressed representation (e.g., latent space) can serve as the embedding. In some aspects, multi-modal embedding may also be applied for data of user query 212 that comes from multiple modalities including but not limited to texts, images, audios, and/or videos. The goal of multi-modal embedding is to create a shared embedding space where similar items from different modalities are close to each other, regardless of the modality these items may originate from. This shared embedding space may be beneficial to at least cross-modal retrieval, multi-modal classification, and/or multi-modal generation to be performed by response generation system 100.

In 216, a similarity search may be performed to retrieve the relevant texts and documents, and/or any data with multiple modalities within vector database 210 that are semantically close to the calculated embedding of user query from 214. In some aspects, the search process of response generation system 100 may involve indexing texts or fragments and/or chunks of texts within vector database 210 based on their semantic representation from vector embedding generation. The key idea behind vector search databases (e.g., similarity search) is to represent data items (e.g., texts, images, documents, audios, user profiles, etc.,) as vectors in a high-dimensional space. The query vector may typically be generated from 214 using the same feature extraction or embedding technique used to create the indexed vectors in 206. Similarity between vectors may then be measured using a distance metric, such as cosine similarity, Euclidean distance, or dot product. The goal of a vector search database is to quickly find the most similar vectors to a given query vector.

In some aspects, response generation system 100 may apply vector search to find similar data using ANN algorithms. When a query point is provided, the ANN algorithm may use an index to quickly identify a set of candidate points that are likely to be close to the query point. This way, when querying the vector database 210 to find the nearest neighbors of a query vector, instead of computing distances between the query vector and all vectors in the vector database 210, response generation system 100 may only compute distances between the query vector and the small number of candidate vectors around the query vector.

For example, in the context of ANN algorithms, locality-sensitive hashing (LSH), may be applied by response generation system 100 to find similar data. LSH is based on the idea of hashing similar points to the same hash bucket. The vector database 210 may be hashed multiple times using different hash functions, each of which may be designed to ensure that similar points are likely to collide. During the query phase, the query vector may be hashed using the same hash functions, and the algorithm may retrieve the vectors that are likely to collide in the corresponding hash buckets as candidates. For example, k-d trees may also be used by response generation system 100 to find similar data. K-d trees are binary search trees that partition the data along different dimensions at each level of the tree. During the construction of the k-d tree, response generation system 100 may select a dimension and a splitting value to partition the vectors into two subsets. The process may be recursively applied to each subset until the tree is fully constructed. During the query phase, response generation system 100 may traverse the k-d tree to find the nearest neighbors of a query vector. In addition, hierarchical navigable small world (HNSW) algorithm may be used by response generation 100 to search similar vectors in high-dimensional spaces. HNSW may construct a hierarchical graph where each node represents a vector, and edges connect nearby vectors. The graph may have multiple layers, with each layer representing a different level of granularity. HNSW algorithm may allow for efficient nearest neighbor searches by traversing the graph's layers. In some aspects, one or more ANN algorithms and/or other techniques may be combined to form a hybrid approach for efficient similarity search in the vector space. For example, scalable nearest neighbors (ScaNN) algorithm may be used by response generation system 100 to efficiently search for nearest neighbors in large-scale, high-dimensional vector database. ScaNN may achieve high search accuracy and speed by combining several techniques, including quantization, vector decomposition, and graph-based search.

In some aspects, response generation system 100 may also use key word search to retrieve the relevant data chunks under instances where matching specific strings of the data chunks may be useful. For example, when searching for a proper name or a specific phrase, a keyword search might be more appropriate than a similarity search between different vectors. This approach may allow response generation system 100 to find texts and/or documents that may contain the exact name or phrase that the user is looking for, ensuring that the results are relevant to their user query 212.

In 218, after querying a set of candidate vectors that are likely to be close to the query vector, the set of data chunks corresponding to the set of candidate vectors may be retrieved from the vector database 210. Response generation system 100 may then rank the set of data chunks to obtain top-k matched data chunks.

In some aspects, response generation system 100 may rank the retrieved data chunks by their relevance, similarity, and/or other scores to the query and fill the context window of LLM depending on the LLM capability, preferably, the top-k matched data chunks include five to ten data chunks that are ranked and curated in 218. In some aspects, the number of data chunks retrieved may be a different number depending on the specific tasks. However, this may result in too much or not enough information being included in the context window of LLM. Techniques including but not limited to creating summaries or combining different texts and/or data chunks semantically can help build a well-suited set for the top-k matched data chunks-that is, by shortening a paragraph-length data chunk to one or more sentences, the retrieved information may become simple, and more summaries can be included in subsequent analysis.

In some aspects, response generation system 100 may also curate (e.g., refine and/or filter) the set of data chunks 218 obtained retrieved from vector database 210. In some aspects, response generation system 100 may use metadata associated with the retrieved data chunks to refine the search results. For example, response generation system 100 may use date to prioritize newer data chunks or focus on data chunks from a specific time period. Response generation system 100 may also use tags and/or categories to limit or prioritize search results based on relevant tags or categories, as they may have already been identified and classified. In addition, response generation system 100 may focus on particular sources or authors to ensure relevance of the search results. By incorporating metadata into the search process, it may enable response generation system 100 to become possible to limit the similarity search or boost rankings, leading to more accurate and relevant search results.

In some aspects, the refining and/or filtering process can be performed either before or after the similarity search itself. For example, in pre-filtering approach, metadata filtering may be done before the vector search to reduce the search space. In post-filtering approach, the metadata filtering may be done after the vector search, further refining the vector search to retrieve the relevant search results. To optimize the pre- and/or the post-filtering process, response generation system 100 may use various techniques including but not limited to leveraging advanced indexing methods for metadata or using parallel processing to speed up the filtering tasks. Balancing the trade-offs between search performance and filtering accuracy may also be essential for providing efficient and relevant query results in vector database 210.

In 220, response generation system 110 may provide LLM input 220 based on the top-k data chunks obtained from 218. The LLM input may include but is not limited to a prompt 220a, a query context and instruction 220b, and/or retrieved information 220c.

For example, in the context of LLM input for steering the LLM, prompt 220a can include text such as:
“You are a Customer Service Agent. Write an email reply to this incoming Case. The CONVERSATION section describes an issue the customer is contacting you, the agent, to address. The CONVERSATION section describes an issue the customer is contacting you, the agent, to address. If the customer's words may be considered unethical and inappropriate, you must not repeat the inappropriate words in the response.”

In the above example, the CONVERSATION is denoted as upper case. This CONVERSATION may be hydrated by a user query 212 received from data source 110 in the example of FIG. 1. The hydration can be performed by prompt builder of data source 110 in the example of FIG. 1.

For example, in the context of LLM input for steering the LLM, prompt 220a after incorporating retrieved information 220c can include text such as:
“You are a Customer Service Agent. Write an email reply to this incoming Case, using information from the ARTICLES section provided below. The CONVERSATION section describes an issue the customer is contacting you, the agent, to address. The ARTICLES section may contain information that will help you respond to the customer's issue. If the customer's words may be considered unethical and inappropriate, you must not repeat the inappropriate words in the response.”

In the above example, the ARTICLES is denoted as upper case. This ARTICLES may be hydrated by the relevant object data retrieved from vector database 210 (a part of database 170 in the example of FIG. 1) in the example of FIG. 2.

For example, in the context of LLM input for steering the LLM, the JSON format with a desired format for steering the LLM can include the text such as:

```
Respond using the following JSON format:
Desired format:
{{
  “article_relevant”: <0 or 1>,
  “responses”: [
  {{
    “response”: “<generated_response>”,
    “intent”: “<short response or none>”,
    “source”:
      {{
        “id”: <id>,
        “sourceRecordId”: <sourceRecordId>,
        “entity”: <entity>,
        “snippet_starting_word_num”: “<start_word_number>”,
        “snippet_ending_word_num”: “<end_word_number>”
      }}
  }}]
}}
```

In the above example, merge fields are denoted as enclosed in double-curly braces. These merge fields can be hydrated by the relevant object data as may be drawn from database 170, user configuration 226 (a part of data source 110 in the example of FIG. 1), and/or vector database 210 (a part of database 170 in the example of FIG. 1). In particular, the “article_relevant” may be hydrated by the retrieved texts, document, and/or data chunks from vector database 210 using an identified “source” directory.

For example, in the context of the LLM input, the query context and instruction 220b can include text such as:
You must strictly follow my instructions below to generate the email:
1. Create an email responding to the issues described in the CONVERSATION submitted by the customer by using information found in the ARTICLES section.
2. When addressing the customer in the email response, strictly use this string: “Dear {{{{{{Recipient.FirstName}}}}}}”
3. When signing off the email, strictly use this string: “Best regards {{{{{{Sender.FirstName}}}}}}”.
4. Express professionalism with deontic modality and declarative sentences in the content, and if needed, instruct the customer step-by-step through the resolution path they must follow for their issue. Avoid making any assumptions about any information that is not specifically described in either the ARTICLES section or the provided case.
5. In the event that you cannot find a solution or response based on the knowledge articles, generate the following Fallback Message.
Fallback Message: “Warning: Current Knowledge Articles do not provide information for a proper response to this issue.”

In the above example, merge fields are denoted as enclosed in sextuple-curly braces. These merge fields can be hydrated by the relevant object data as may be drawn from user configuration 226 (a part of data source 110 in the example of FIG. 1).

In 222, response generation system 100 may query the LLM via LLM gateway 150 using the LLM input provided in 220. In some aspects, response generation system 100 may make one or more LLM calls to address a certain tasks depending on the task difficulty and the LLM capability. In some aspects, different LLMs may be queried via LLM gateway 150. The number of LLM calls multiplies for each task, which can lead to increased costs. Balancing these factors of querying LLM may help to optimize response generation system 100 for both performance and cost-efficiency.

In 224, response generation system 100 may generate user query response based on the LLM response from querying the LLM in 222 and user configuration 226 received from data source 110. In some aspects, user configuration 226, received from data source 110 may refer to the user attributes defined per prompt template and/or a user preference for generating the response, including but not limited to a user profile, and/or any parameters such as subject, body, and related records for an email template. Response generation system 100 may allow users to navigate to and define parameters such as subject, body, and related records for an email template in user configuration 226. In some aspects, response generation system 100 may provide users a syntax such as [[[GENERATED_CONTENT_HERE]]] to configure the location in the email template body where the generated content will be placed.

For example, a sample generated email response, e.g., user query response generated in 224, can include text such as:

Dear {{{{{{Recipient.FirstName}}}}}},
<body_of_the_email_response>
Best regards
{{{{{{Sender.FirstName}}}}}}

In the above example, merge fields are denoted as enclosed in sextuple-curly braces. These merge fields may be hydrated by the relevant object data (e.g., author name) as may be drawn from user configuration 226 (a part of data source 110 in the example of FIG. 1). Also, the <body_of_the_email_response> may be hydrated by the user query response generated from 224.

Response generation system 100 may then determine whether the user query response generated from 224 has achieved a quality threshold for an auto-response. In some aspects, if the generated user query response has achieved the quality threshold, response generation system 100 may, in 228, output the user query response back to the sender as auto-response. In some aspects, if the generated user query response has not achieved the quality threshold, response generation system 100 may, in 230, route the user query response to an agent for additional review and/or feedback. Response generation system may, in 232, update the user query response by incorporating an agent feedback. In addition, response generation system, in 228, may then output the updated user query response back to the sender.

In some aspects, response generation system may use some form of agent input (a part of data source 110 in the example of FIG. 1) to kick off the generation of an email response. For example, one or more agents may provide response generation system 110 for what type of email response to draft and which texts and/or documents to use in drafting that email response using natural language, texts, and/or other multi-modal inputs. The one or more agents may also select from a list the type of email that they want to have response generation system 100 to draft.

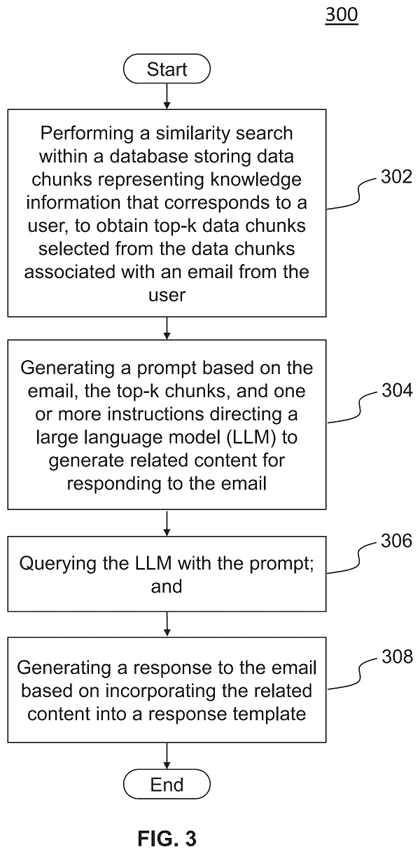

FIG. 3 is a flowchart illustrating a method 300 for email response drafting, grounding, generation, and/or auto-response, according to aspects of the present disclosure. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1 and FIG. 2. However, method 300 is not limited to that example aspect.

In 302, a similarity search may be performed within a database storing data chunks representing knowledge information that corresponds to a user to obtain top-k data chunks selected from the data chunks associated with an email from the user. In some aspects, generating the database may include but is not limited to tokenizing text to obtain the data chunks, generating a first data embedding associated with a data chunk, generating one or more vector indexes to store data chunks and a set of the first data embedding associated with the data chunk, and/or storing the one or more vector indexes into the database. In some aspects, a second data embedding may be generated associated with the email from the user.

In some aspects, the performing of the similarity search may include but is not limited to calculating a set of distance metrics between the second data embedding associated with the email and the set of the first data embedding associated with the data chunk, identifying a plurality of candidate data chunks stored in the vector indexes in the database based on a relationship between the set of calculated distance metrics and a threshold, and/or ranking the set of calculated distance metrics associated with the plurality of candidate data chunks to generate the top-k data chunks. In some aspects, the distance metric may include but is not limited to a cosine similarity, a Euclidean distance, and/or a dot product.

In 304, a prompt may be generated based on the email, the top-k data chunks obtained from 302, and one or more instructions directing a LLM to generate related content for responding to the email.

In 306, a LLM may be queried with the prompt generated from 304.

In 308, a response to the email may be generated based on incorporating the related content generated from querying the LLM in 306 into a response template. In some aspects, the response template may be configurable by a user configuration including but not limited to a subject, a body, and a related record associated with the response template.

In some aspects, whether the generated response has achieved a quality threshold for an auto-response may be determined, and/or the generated response may then be routed to an agent for review based on the generated response not having achieved the quality threshold or be sent back to the user based on the generated response having achieved the quality threshold.

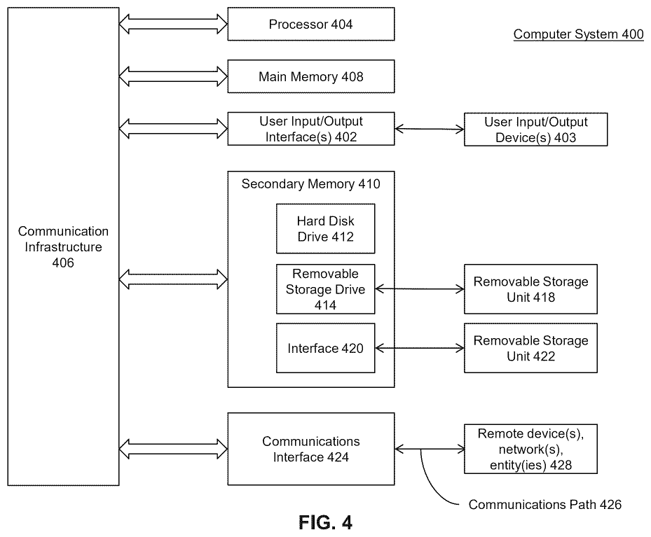

Various aspects may be implemented, for example, using one or more well-known computer systems, such as computer system 400 shown in FIG. 4. For example, aspects herein using the text summarization system may be implemented using combinations or sub-combinations of computer system 400. Also or alternatively, one or more computer systems 400 may be used, for example, to implement any of the aspects discussed herein, as well as combinations and sub-combinations thereof. A “module,” as the term is used herein, is a computational element that performs one or more functions according to computer readable instructions stored on one or more memories or other non-transitory computer-readable media.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400 or processor(s) 404), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 4. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method, comprising:
performing a similarity search, by one or more computing devices, within a database storing data chunks representing knowledge information that corresponds to a user, to obtain top-k data chunks selected from the data chunks associated with an email from the user;
generating, by the one or more computing devices, a prompt based on the email, the top-k data chunks, and one or more instructions directing a large language model (LLM) to generate related content for responding to the email;
querying, by the one or more computing devices, the LLM with the prompt; and
generating, by the one or more computing devices, a response to the email based on incorporating the related content into a response template.

2. The method according to claim 1, wherein generating the database comprises:
tokenizing text to obtain the data chunks;
generating a first data embedding associated with a data chunk, wherein the first data embedding is a multi-dimensional numerical representation of a semantic meaning of the data chunk;
generating one or more vector indexes to store the data chunks and a set of the first data embedding associated with the data chunks; and
storing the one or more vector indexes into the database.

3. The method according to claim 1, wherein the performing the similarity search comprises:
generating a second data embedding associated with the email from the user, wherein the second data embedding is a multi-dimensional numerical representation of a semantic meaning of the email;
calculating a set of distance metrics between the second data embedding associated with the email and a set of a first data embedding associated with the data chunks;
identifying a plurality of candidate data chunks stored in the vector indexes in the database based on a relationship between the set of calculated distance metrics and a threshold; and
ranking the set of calculated distance metrics associated with the plurality of candidate data chunks to generate the top-k data chunks.

4. The method according to claim 3, wherein the calculating the set of distance metrics is performed by determining at least one of a cosine similarity, a Euclidean distance, or a dot product between the second data embedding and the set of the first data embedding.

5. The method according to claim 1, wherein the response template is configurable by a user configuration comprising a subject, a body, and a related record associated with the response template.

6. The method according to claim 1, further comprising:
determining whether the generated response has achieved a quality threshold for an auto-response; and
routing the generated response to an agent for review based on the generated response not having achieved the quality threshold, or sending the generated response back to the user based on the generated response having achieved the quality threshold.

7. A system, comprising:
a memory configured to store operations; and
one or more processors configured to perform the operations, the operations comprising:
performing a similarity search within a database storing data chunks representing knowledge information that corresponds to a user, to obtain top-k data chunks selected from the data chunks associated with an email from the user;
generating a prompt based on the email, the top-k data chunks, and one or more instructions directing a large language model (LLM) to generate related content for responding to the email;
querying the LLM with the prompt; and
generating a response to the email based on incorporating the related content into a response template.

8. The system according to claim 7, wherein generating the database comprises:
tokenizing text to obtain the data chunks;
generating a first data embedding associated with a data chunk, wherein the first data embedding is a multi-dimensional numerical representation of a semantic meaning of the data chunk;
generating one or more vector indexes to store the data chunks and a set of the first data embedding associated with the data chunks; and
storing the one or more vector indexes into the database.

9. The system according to claim 7, wherein the performing the similarity search comprises:
generating a second data embedding associated with the email from the user, wherein the second data embedding is a multi-dimensional numerical representation of a semantic meaning of the email;
calculating a set of distance metrics between the second data embedding associated with the email and a set of a first data embedding associated with the data chunks;
identifying a plurality of candidate data chunks stored in the vector indexes in the database based on a relationship between the set of calculated distance metrics and a threshold; and
ranking the set of calculated distance metrics associated with the plurality of candidate data chunks to generate the top-k data chunks.

10. The system according to claim 9, wherein the calculating the set of distance metrics is performed by determining at least one of a cosine similarity, a Euclidean distance, or a dot product between the second data embedding and the set of the first data embedding.

11. The system according to claim 7, wherein the response template is configurable by a user configuration comprising a subject, a body, and a related record associated with the response template.

12. The system according to claim 7, wherein the one or more processors are further configured to perform operations comprising:
determining whether the generated response has achieved a quality threshold for an auto-response; and
routing the generated response to an agent for review based on the generated response not having achieved the quality threshold, or sending the generated response back to the user based on the generated response having achieved the quality threshold.

13. A non-transitory computer-readable storage device having instructions stored thereon, execution of which, by one or more processing devices, causes one or more processors to perform operations comprising:
performing a similarity search within a database storing data chunks representing knowledge information that corresponds to a user, to obtain top-k data chunks selected from the data chunks associated with an email from the user;
generating a prompt based on the email, the top-k data chunks, and one or more instructions directing a large language model (LLM) to generate related content for responding to the email;
querying the LLM with the prompt; and
generating a response to the email based on incorporating the related content into a response template.

14. The non-transitory computer-readable storage device according to claim 13, wherein generating the database comprises:
tokenizing text to obtain the data chunks;
generating a first data embedding associated with a data chunk, wherein the first data embedding is a multi-dimensional numerical representation of a semantic meaning of the data chunk;
generating one or more vector indexes to store the data chunks and a set of the first data embedding associated with the data chunks; and
storing the one or more vector indexes into the database.

15. The non-transitory computer-readable storage device according to claim 13, wherein the performing the similarity search comprises:
generating a second data embedding associated with the email from the user, wherein the second data embedding is a multi-dimensional numerical representation of a semantic meaning of the email;
calculating a set of distance metrics between the second data embedding associated with the email and a set of a first data embedding associated with the data chunks;
identifying a plurality of candidate data chunks stored in the vector indexes in the database based on a relationship between the set of calculated distance metrics and a threshold; and
ranking the set of calculated distance metrics associated with the plurality of candidate data chunks to generate the top-k data chunks.

16. The non-transitory computer-readable storage device according to claim 15, wherein the calculating the set of distance metrics is performed by determining at least one of a cosine similarity, a Euclidean distance, or a dot product between the second data embedding and the set of the first data embedding.

17. The non-transitory computer-readable storage device according to claim 13, wherein the response template is configurable by a user configuration comprising a subject, a body, and a related record associated with the response template.

18. The non-transitory computer-readable storage device according to claim 13, wherein the operations further comprising:
determining whether the generated response has achieved a quality threshold for an auto-response; and
routing the generated response to an agent for review based on the generated response not having achieved the quality threshold, or sending the generated response back to the user based on the generated response having achieved the quality threshold.
